(19) United States
(12) Patent Application Publication
(10) Pub. No.: US 2008/0301049 A1
(43) Pub. Date: Dec. 4, 2008

(54) Transaction Management System

(75) Inventor: Roderick Mark Dyson, Gauteng (ZA)

Correspondence Address: BIRCH STEWART KOLASCH & BIRCH, PO BOX 747, FALLS CHURCH, VA, 22040-0747, US

(73) Assignee: Roderick Mark DYSON, Midrand, Gauteng (ZA)

(21) Appl. No.: 12/083,089

(22) PCT Filed: Oct. 4, 2006
(86) PCT No.: PCT/ZA2006/000115

§ 371 Date: Jul. 3, 2008

(30) Foreign Application Priority Data
Oct. 4, 2005 (ZA) 2005/08213
Jun. 8, 2006 (ZA) 2006/04692
Aug. 7, 2006 (ZA) 2006/06534
Aug. 7, 2006 (ZA) 2006/06536

(51) Int. Cl. G06Q 40/00

(52) U.S. Cl. 705/42; 705/35

(57) ABSTRACT

The transaction management system 100 includes a plurality of individually identifiable secure container holding facilities constituted by cash acceptance terminals 112 located at the premises of participating merchants 114 and a plurality of individually identifiable secure containers or cash containers, each adapted to dock with and un-dock from a cash acceptance terminal 112. The merchants 114, in each transaction, deposit transaction documents such as money, cheques, credit card vouchers or the like into the secure container within the cash acceptance terminal 112. Cash money fed into the cash acceptance terminal is scanned, validated and counted into the secure container. The cash acceptance terminals 114 include data entry facilities by means of which data pertaining to transactions is recorded in the cash acceptance terminal. The secure containers and the cash acceptance terminals 112 are adapted for bidirectional communication and the data recorded in the cash acceptance terminal 112 is communicated to the secure container. The transaction management system 100 includes a central server 118 in communication with the data processing system of a number of financial institutions 120. The cash acceptance terminals 112 are programmed to communicate with the server 118. Purchasers 116 are able to use the cash acceptance terminals 112 as banking facilities and, using a cash acceptance terminal with a facility to recirculate and to dispense cash, the system may be programmed to allow the cash acceptance terminals 112 to dispense cash and credit value, thereby allowing a purchaser to use a cash acceptance terminal 112 like an automated teller machine (ATM) to draw cash, to transfer money between accounts, for bill payment or the like. Using an appropriate tracking and scheduling system, the central server 118 is programmed to record the identity and location of each cash acceptance terminal and every secure container in the system 100 as well as the monetary value stored in or to be obtained from each cash acceptance terminal and secure container in the system which enables the system operator and participating financial institutions 120 to manage the flow of cash within the system 100 without necessarily routing each cash consignment through a cash processing centre 124 or financial institution 120. The transaction management system 100 is essentially a cash bank with a cash repository that is not constituted by a conventional vault, but by a virtual repository constituted by the secure cash acceptance terminals 112 and secure containers that are all tracked and audited by the system 100.

### BACKGROUND TO THE INVENTION

This invention relates to a transaction management system.

The invention finds particular application as a transaction management system as well as a system for the management of valuables and transaction documents in transit. The invention will be described with reference to such applications and a cash in transit system in particular. It will be appreciated, however, that this is done purely for illustration and it is not intended to limit the scope of the invention to such particular examples.

The typical cash in transit system makes use of a plurality of secure containers that are used to transport either or both cash and transaction documents.

The term “transaction document” will be used, in this specification, to denote any document associated with any transaction, whether for valuable consideration or otherwise and if the context permits, is intended to include a reference to any document normally used in commerce to initiate, conclude or record a transaction. Examples of such transaction documents include money, cheques, credit card vouchers, deposit- and withdrawal vouchers or slips and printouts of electronic payment records.

Since cash in transit systems must deal with money which normally includes paper money and coin money, the term “cash” will, where the context allows, include a reference to the transaction documents referred to above and to coin money.

The secure containers used in conventional cash in transit systems are constituted by secure boxes or containers with one or more compartments that are accessible via electronically controlled doors or hatches. Cash is deposited into one or more of the compartments in the secure container by means of dedicated cash acceptance terminals and removed by means of dedicated opening jigs located at one or more cash processing centres.

The secure container is normally protected by means of a dye mechanism that can be activated (normally in an alarm situation or when the integrity of the container is compromised) to release a document staining dye into the interior of the container, thereby to stain and mark the transaction documents within the container as documents that emanate from a compromised container.

The secure container is adapted to dock with one or more secure container holding facilities constituted, at one end of the transaction chain (the cash receiving end) by secure cash acceptance terminals and, at the other end of the transaction chain (the cash processing end) by the cash processing jigs used in cash processing centres.

The term “dock”, in this specification, will be used to refer to the actions of inserting and locating the secure container within a secure container holding facility, such as a cash acceptance terminal or cash processing centre opening jig, and electronically interfacing the secure container with the secure container holding facility such that bidirectional communication between the secure container and the secure container holding facility can take place, if necessary, and the contents of the container can be removed either automatically, which is preferred, or manually.

A cash acceptance terminal is essentially a secure holding facility for a secure container, which is securely housed within a docking bay forming part of the cash acceptance terminal. Cash acceptance terminals are normally located at cash acceptance points, normally the premises of retailers, merchants, financial institutions or other organisations that receive cash and need to have the cash transported to and from their premises. The cash acceptance terminal is provided with a feed chute through which the cash is fed into a banknote transport system that transports the notes through the cash acceptance terminal and past note validators and scanners included in the cash acceptance terminal. The banknote transport system deposits the banknotes into a secure container docked within the cash acceptance terminal docking bay. The document travel path within the cash acceptance terminal typically includes a note validator with a note reject facility, a card reader and a mechanism, such as a tag or identity card reader, to verify one or more of client-, user- and operator identification.

When the secure container is filled to its operational capacity and the cash has to be moved from the cash acceptance point (the premises of the retailer or other organisation that receives cash and needs to have the cash transported to and from their premises), the container is un-docked from the cash acceptance terminal and transported, with the assistance of a cash in transit service provider, to a cash processing centre.

The cash acceptance terminals can be static or mobile.

Static cash acceptance terminals are constituted by safe-like, back office machines that have one or more secure containers docked and securely stored within the cash acceptance terminal, which is typically housed in a non-public, secure facility within the premises of a cash receiving organisation such as a retailer.

Mobile cash acceptance terminals, have at least one secure container docked within the cash acceptance terminal and are mounted on wheels or castors so that they can be wheeled around.

Using a cash acceptance terminal as an example, in the process of docking the secure container with the cash acceptance terminal, an empty secure container is located in the cash acceptance terminal docking bay through a normally locked docking bay door, which is opened for this purpose. Both the cash acceptance terminal and the secure container are provided with programmable logic that is programmed to automate and co-ordinate the operation of the cash acceptance terminal and the secure container.

The cash processing centre is typically constituted by a cash handling facility that contains one or more container processing jigs each of which is either networked within the cash processing centre or provided with onboard or processing power adapted to interface with the cash processing centre computer system. The emptying jigs are used to open the secure containers, thereby to allow the cash and transaction documents contained in the secure containers to be retrieved, counted, reconciled and transferred into bulk document sorting and storage systems, in separate manual processes.

At both ends of the process, that is when the secure container is docked with a cash acceptance terminal or with a processing jig at the cash processing centre, a reciprocal authentication procedure takes place to verify the component identities and the authorisation of the components to undergo the various processes undertaken within the system, such as opening the secure container, depositing cash into the secure container and discharging cash from the secure container at the cash processing centre. Such authentication is done with the use of digital cryptographic techniques.

The secure containers, cash acceptance terminals and the processing jigs at cash processing centres are all provided with bidirectional communication means to enable data and cryptographic data communication between devices.

### SUMMARY OF THE INVENTION

According to the invention a transaction management system is provided including:
a plurality of individually identifiable secure container holding facilities;
a plurality of individually identifiable secure containers each adapted to dock with and un-dock from a secure document handling facility;
the container holding facilities being adapted for location at the premises of a plurality of participating merchants, each of whom, in use, takes part in transactions in each of which the merchant receives one or more transaction documents reflecting monetary value, from one or more purchasers in exchange for goods delivered or services rendered and in which the merchant deposits, into a secure container docked within the holding facility, the transaction document or documents involved in that transaction;
each secure container and holding facility including bidirectional communication means adapted to communicate, to and from the secure containers, data pertaining to the monetary value of each transaction document deposited in the secure container;
a central, computerised transaction management facility in communication with the data processing system of at least one financial institution with which the merchants have banking accounts;
means to communicate at least the monetary value data recorded by the holding facilities to the central, computerised transaction management facility; and
the server being programmed, on receipt of a communication from a holding facility located at the premises of a merchant, to communicate data pertaining to the combined monetary value of all the transaction documents deposited within the secure container to the financial institution with whom the merchant has a banking account.

Given the secure nature of the components making up the system of this invention, particularly the secure containers and the secure container holding facilities with note validation capacity, there is sufficient trust built into the system to permit the financial institution to immediately credit the banking account of the merchant with the monetary value communicated to the financial institution.

The system is not limited or restricted to merchants in the strict sense of the word and the terms “purchasers”, “merchants” and “premises of participating merchants” should be seen in the light of persons engaging in commercial transactions using transaction documents that are exchanged for value at a place (which need not be a fixed place) where a secure container holding facility can be deployed. The terms are therefore inclusive of any number of persons, from merchants proper, to financial institutions, private individuals, casinos or the like.

In essence, the money (or monetary value) can be considered to be “banked” when the transaction documents are counted into the secure container holding facility and the value so counted in is communicated to the financial institution.

The secure container holding facility, such as a container holding facility, is located at the premises of a participating merchant or other cash recipient, who has the opportunity of “banking” the contents of the secure container, either by allowing the system to communicate with the financial institution at a prescribed time or times or when the secure container is filled to capacity or by initiating communication manually.

Notwithstanding that multiple deposits of transaction documents from a single merchant are made into the secure container, the communication to the financial institution may conveniently be recorded as a single credit to the banking account of the participating merchant.

In a situation in which the merchant receives cash for the account of the merchant and for the account of others, the system may be programmed to permit the merchant to deposit cash into the secure container and to designate the account or accounts to be credited in respect of that deposit. So, for instance, the merchant may feed two lots of cash into the secure container through the secure container holding facility. The first deposit may be for the credit of the merchant's bank account. The second deposit may be cash retrieved from a lottery container holding facility, which deposit will be designated for the credit of the lottery operator.

The communication means preferably includes means to communicate the data recorded by the holding facilities to the central, computerised transaction management facility.

The transaction management system may be adapted to enable a purchaser to use the secure container holding facility as a bank cash withdrawal facility, the transaction management system being programmed:
to record data pertaining to the cash withdrawal required and the purchaser's banking details;
to communicate this data to the financial institution where the purchaser has a banking account;
to instruct the financial institution to debit the purchaser's bank account with the amount withdrawn and possibly even a handling charge;
to instruct the financial institution to credit the merchant's bank account with the amount withdrawn and possibly even a handling charge;
to dispense cash to the purchaser from the secure container holding facility.

In this embodiment of the invention, the container holding facility operates much like an automated teller machine (ATM).

In a further embodiment of the invention, the secure container holding facility may be set up to operate as a cash account payment facility, the transaction management system being programmed:
to instruct the container holding facility to accept the in-feed of the payment in cash into the container holding facility;
to record data pertaining to the cash payment fed into the container holding facility and the account payee's banking details;
to communicate this data to the financial institution where the account payee has a banking account; and
to instruct the financial institution to credit the payee's bank account with the amount withdrawn and possibly even a handling charge.

The transaction management system is preferably adapted to manage transactions concluded within the system as well as the contents of each secure container under the control of the central, computerised transaction management facility, using bidirectional communications between the secure container holding facilities, the secure containers, participating merchants, one or more participating cash processing centres and one or more participating financial institutions.

In this embodiment of the invention the central transaction management facility may conveniently include programmable logic means to record the identity and location of each secure container holding facility and secure container in the system as well as an indication of the monetary value, in the form of actual cash and value represented by other transaction documents, stored or to be obtained from each secure container holding facility and secure container.

This will make it possible for the central facility and the participating financial institutions, with the use of suitable computers and software, to manage and schedule cash transfers and the flow of cash within the system without necessarily routing each cash consignment through a cash processing centre or financial institution.

The container holding facility may include one or more internal escrow areas, means to feed cash of a particular type from the container holding facility in-feed mechanism temporarily into discrete escrow areas, in addition to or instead of placing the cash into the secure container, and cash feed means to recirculate the cash between the escrow areas, the secure container and the container holding facility in-feed mechanism.

Using such a container holding facility, the system may be programmed to sort the banknotes into the secure container to suit the known cash requirements of one or more of the other participating merchants in the system.

The central facility, the container holding facilities and the secure containers may be programmed such that no secure container can be opened without compromising the integrity of the secure container unless it is empty of all transaction documents or it is securely locked within and electronically interfaced with a secure container holding facility.

Bidirectional communication and programmable logic means in the secure container holding facility and the secure container interfaced therewith are used to open the secure container automatically when the secure container holding facility is locked and secure, so that cash can be fed into or discharged from the secure container by means of the secure container holding facility. In all other situations, when the secure container holding facility is opened or the security thereof is compromised in any way, the secure container must be locked and secured.

In the transaction management system of the invention, each secure container preferably includes programmable logic means to record and store data pertaining to each transaction document stored within the secure container, the secure container including means to communicate, to a control device located externally of the secure container, information pertaining to the secure container and each transaction document.

In addition, at least some of the secure containers may be adapted to facilitate the recycling and withdrawal of transaction documents from the secure container, each such container including one or more compartments additional to a main transaction document holding compartment, which additional compartments are adapted to constitute escrow areas, float compartments or holding areas for denomination-specific transaction documents from which the or such documents can be dispensed in use.

In this form of the invention the secure containers may each be provided with an on-board processor with sufficient computing power and memory to store a record of the transactions involving the secure container or any holding facility within which the secure container is held, including data pertaining to transaction documents deposited into the container, transaction documents withdrawn from the container (or any additional compartment, whether forming part of the container or the holding facility within which the container is housed), all deposits into the secure container (or any additional compartment, whether forming part of the container or the holding facility within which the container is housed), all withdrawals from the secure container (or any additional compartment, whether forming part of the container or the holding facility within which the container is housed) and data pertaining to all transaction documents housed within the secure container and data pertaining to the operational history of the container and a record of any mishandling of the container.

In this embodiment of the invention, the transaction management system relies on a definitive record of all transactions involving transaction documents housed within the container, transaction documents deposited into the container and transaction documents withdrawn from the container (or any additional compartment, whether forming part of the container or the holding facility within which the container is housed). To obtain such a definitive record, the container holding facility is preferably provided with multiple document counting and validation means.

To this end, the container holding facility preferably includes a note or document validator with multiple validation mechanisms, a note reject facility, magnetic stripe and smart card readers, an identity tag or card reader, a biometric scanner or some other mechanism to verify one or more of client-, user- and operator identification, a receipt printer and sufficient onboard processing power to record and store the transactions undertaken with the use of the holding facility or container holding facility.

With such validation means, it can be assured (with a statistically acceptable variance) that the data pertaining to the transaction documents in the container holding facility and secure container is definitive.

With such acceptable data, the secure container when interfaced with an appropriate container holding facility can serve the function, in effect, of an automated teller machine.

To interface with such a secure container, the container holding facility is preferably adapted to facilitate and record the deposit and withdrawal of transaction documents.

In this configuration, the system can be used to manage cash deposits, cash withdrawals as well as deposits and payments in forms other than cash, using the secure container in conjunction with the container holding facility as a medium for receiving deposits and dispensing withdrawals as well as recording, electronically and by way of printed transaction slips, information pertaining to such transactions.

The container holding facility and the secure container are preferably each provided with sufficient electronic processing power to record full details of all transactions managed through the system with the aid of each such container holding facility and secure container. In addition, the container holding facility is in communication with a central transaction management facility to which data pertaining to the transactions involving the container holding facility are uploaded. The record of transactions involving the secure container, besides being uploaded via the container holding facility, are also recorded and transported with the secure container when the secure container is removed from the container holding facility and transported to the cash processing centre. This onboard record of transactions involving the secure container can be used as a parallel verification mechanism.

There is sometimes a requirement for bulk cash deposits into canisters that do not have any on-board intelligence and the system Is adapted to incorporate the use of such canisters.

The transaction management system of the invention offers a cash payment function that is facilitated through a self service or an assisted self service container holding facility, the container holding facility being adapted to accept and validate the cash inserted therein and to communicate with one or more of a merchant or merchants and a financial institution or institutions to credit the appropriate account.

This information can be input or selected from a list of predefined accounts. Once the transaction has been processed, the container holding facility deposits the transaction documents and cash in particular into a secure, dye protected deposit box.

With such validation, the system can “guarantee” payment and enable notification that the transaction is complete, with the recipient receiving a real-time credit.

The transactions possible with the system include cash payments, payments of accounts and utility accounts, prepaid services, ticket purchases and vouchers.

With the use of appropriate escrow facilities in the container holding facility in addition to or alternatively to the facility to deposit and withdraw transaction documents (particularly cash) to and from the secure container, the system also offers the possibility of withdrawing cash against an authorised instruction received from a financial, retail or government institution.

In addition to the communications facility offered by the electronic record stored in or on the secure container, the system conveniently includes parallel communications media including networked computer communications, telecommunications and communicating via the internet or GSM, GPRS or wireless networks.

The secure container holding facilities, besides container holding facilities and cash processing centres, may conveniently include one or more secure container holders that are adapted to dock, receive and securely house a plurality of secure containers.

The secure container holders may be specifically adapted for use in different activity areas of the system.

To provide a more complete transaction management system, one or more bulk container holding facilities may be provided and adapted to house a plurality of secure containers in a secure area.

The bulk secure container holding facility may be constituted by a secure container carousel within which one or more secure containers may be housed, the carousel including:
a cash in transit insertion point including docking means at which an empty secure container may be docked and inserted into the carousel by a cash in transit operator;
a merchant extraction point at which an empty secure container may be un-docked and removed from the carousel by the merchant;
a merchant insertion point including docking means at which a full or partly filled secure container may be docked and inserted into the carousel by the merchant;
a cash in transit extraction point at which the secure container may be un-docked and removed from the carousel by a cash in transit operator; and
conveyor means to transport the secure containers in the carousel between the insertion and extraction points;
each extraction point being provided with bidirectional communications facilities by means of which data pertaining to the secure containers inserted and extracted from the carousel may be exchanged between the carousel, the secure containers and the transaction management system.

Alternatively or in addition, the bulk container holding facility may be constituted by a secure area incorporated into a vehicle of a cash in transit service provider, the bulk facility being adapted to house full or partly filled secure containers in an area accessible only to specifically authorised persons, such as supervisory personnel of a cash in transit operator or a cash processing centre.

In one form of this embodiment of the invention of the invention the bulk facility is preferably a secure vehicle module adapted for mounting in a cash in transit vehicle or the like, the module being constituted by a dye protected, secure facility which is adapted to dock, sequentially and at least one at a time, with a plurality of secure document containers:
to open each secure document container in a manner similar to a cash handling facility emptying jig;
to deposit the contents of the secure document container into the module for storage of the transaction documents so deposited; and
to un-dock the secure document container;
the module including programmable logic adapted to record, preferably by means of communication with the secure document container programmable logic, the bulk transaction documents deposited from the secure document container and a record of each secure document container docked with and un-docked from the module.

The secure document container is preferably constituted by a dye protected, secure container similar to the cash container described above. In addition, the vehicle module may be similarly dye protected.

The secure vehicle module may be constituted by an integrated cash container system similar to the secure document containers described above or by a substantially simplified safe, similar to a mobile drop safe, depending on the complexity and security required of the system.

The secure vehicle module preferably includes bidirectional communication means to permit communication between the secure containers, the vehicle module and the central, computerised transaction management facility.

In addition, the system may be programmed to count and reconcile all cash movements into the cash in transit vehicle when the vehicle, in use, collects cash from participating merchants. When, in use, the cash in transit vehicle reports to a cash processing centre and discharges its load of cash, the total cash count, if it balances with cash counted in, will balance the accounts of all the participating merchants visited by the vehicle.

Since the cash in transit vehicle uses dye-protected secure containers, the vehicle itself need not be armoured. In essence the vehicle replaces armour with intelligence.

The bulk facility may be adapted to discharge cash stored in the facility by automatically undocking the secure containers docked with the vehicle facility or by un-docking and removing the cassette.

Alternatively the cash in transit vehicle may be adapted for the removal of the cash by dispensing the cash stored in the vehicle cassette or secure containers into the secure container of a secure container holding facility. The system, in this embodiment of the invention, may be programmed to reconcile and record all cash movements into and out of the vehicle. In essence, this converts the cash in transit vehicle into a mobile cash processing centre.

The system may be programmed to record the location of particular cash items or classes of cash items, such as banknotes of a particular denomination, in the vehicle. This will facilitate the dispensing of cash from the cash in transit vehicle and vehicle route scheduling.

At the retailer end, the transaction management system may include:
a plurality of static container holding facilities, each adapted to accept and store cash in a container located within the terminal; and
at least one mobile container holding facility with at least one secure container docked within it;
the mobile terminal being adapted to dock with each static terminal and to unload cash stored in the static terminal into the secure container docked within the mobile container holding facility.

The secure container in the static container holding facility is preferably but need not necessarily be a secure container.

The static container holding facilities may be constituted by retail till points or point of sale cash collection points, the system including at least one additional static container holding facility having at least one secure container docked within it, constituting a central cash store, the mobile container holding facility being adapted to dock with the static container holding facility and to load cash stored within the mobile container holding facility into the static container holding facility for storage thereof in one or more secure containers docked within the central static container holding facility.

The static container holding facilities are preferably connected together in a communications network.

In this embodiment of the invention the system preferably includes means to monitor the movement of the mobile container holding facility and to raise an alarm if the mobile container holding facility exceeds the parameters of a predefined, restricted set of movements.

### BRIEF DESCRIPTION OF THE DRAWINGS

The invention will be further described with reference to the accompanying drawing which is a block and flow diagram outlining the basic components of the transaction management system of the invention.

FIG. 1 is a block and flow diagram outlining the basic components of the transaction management system of the invention;

FIG. 2 is a block and flow diagram outlining the core processes involved in the transaction management system;

FIG. 3 is a block diagram of aspects of the management system of this invention; and

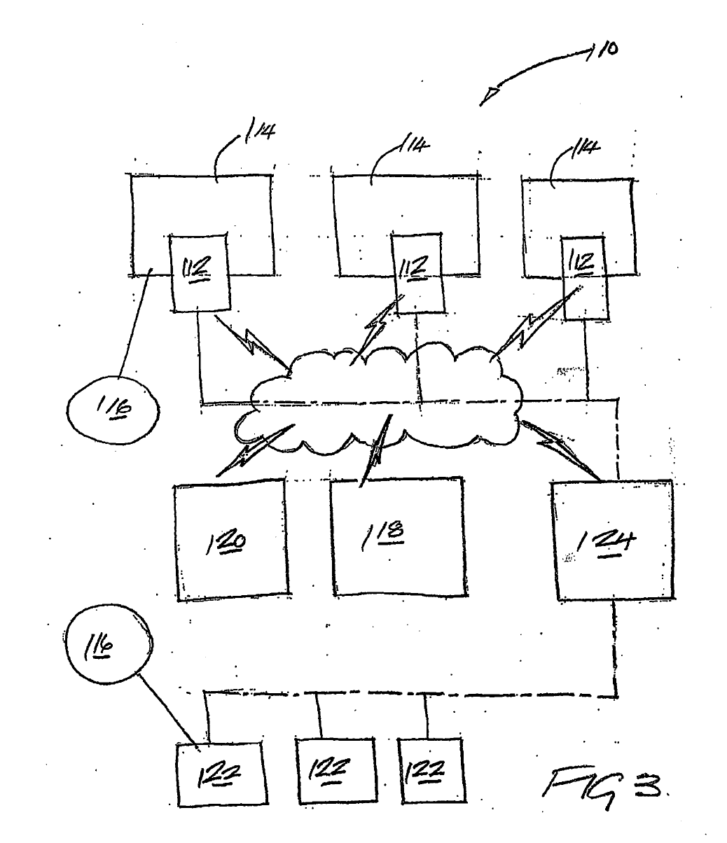

FIG. 4 is a diagrammatic representation of a vehicle module according to the invention.

### DESCRIPTION OF EMBODIMENTS OF THE INVENTION

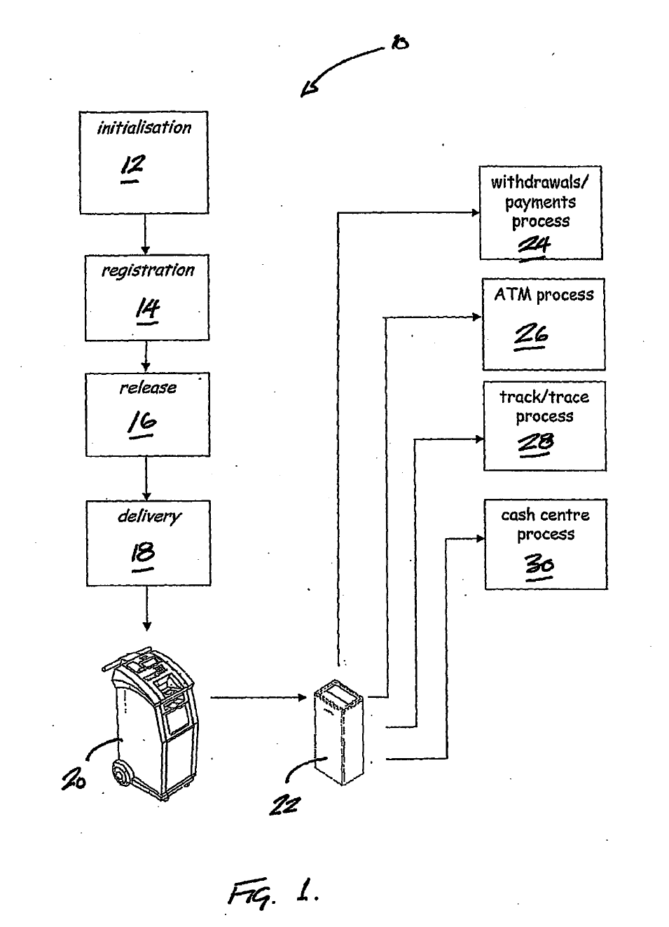

The transaction management system (as illustrated in FIG. 1) relies on the utilisation of an enhanced secure container or secure container 22.

The secure container 22 is manufactured and initialised with a unique serial number and dye pack. The secure container 22 is preferably also provided with a remote tracking device. This is all done in a first process step 12.

In a subsequent process step 14, the secure container 22 is registered on the transaction management system and allocated to a region and cash processing centre. In process step 16, the secure container 22 is released and delivered by a cash in transit operator to a user of the transaction management system (a participating retailer for instance) in unarmed mode. On delivery 18, the cash in transit operator or the retailer or both register the secure container 22 to that particular retailer or user, ready for use in the user's cash acceptance terminal 20.

On delivery 18, the cash in transit operator or the retailer or both register the secure container 22 to that particular retailer or user.

The process of registration is preferably integrated into an end-to-end tracking system implemented electronically and by way of business processes, to record definitive changes of custody of the secure containers 22. The tracking system is programmed to issue delivery receipts, recording data pertaining to the secure containers 22 involved as well as the entities involved in the handover of custody. This data is recorded centrally within the transaction management system to provide auditable data of secure container movements as well as performance and management statistics.

When a secure container 22 is delivered by a cash in transit operator, the system is programmed to first verify that the secure container 22 is in a good working order and if not, the cash in transit operator will be notified to remove the secure container 22 and return it for maintenance. This process occurs at all handover points.

On delivery to a merchant for use of the secure container 22, the transaction management system is programmed to personalise the secure container 22 to that merchant prior to deposits into the container 22 being accepted. The system may then be required to complete a further maintenance check and only then is the container 22 armed and deposits enabled.

The secure container 22 is armed so that any notifiable event (any event that impacts on the integrity of the secure container 22) will result in a container response (the dye pack is detonated or an alarm is triggered or both). This is so that some form of action can be elicited from the persons in control of the secure container 22 or from the transaction management system, the user, the cash in transit operator, security personnel or any combination of these groups of people and systems

In use in the cash acceptance terminal 20, the secure container 22 will be moved to a cash receipting point where it is either filled to capacity so that removal from the cash acceptance terminal 20 is imperative or the secure container 22 is removed from the cash acceptance terminal 20 during a scheduled removal.

Upon removal, the secure container 22 remains armed until it is delivered to the cash processing centre.

The secure container 22 once loaded into the cash acceptance terminal 20 and thereafter, is capable of performing a number of functions and participating in a number of processes, each of which is diagrammatically illustrated in FIG. 1. These processes, which will be described below, are made possible by the fact that the secure container 22 (and the cash acceptance terminal 20 if necessary) contain a definitive record of all transactions involving transaction documents housed within the container, transaction documents deposited into the container and transaction documents withdrawn from the container (or any additional compartment, whether forming part of the container or the holding facility within which the container is housed).

To obtain such a definitive record, the cash acceptance terminal 20 is provided with multiple document counting and validation mechanisms to provide definitive note processing during both deposit and withdrawal of transaction documents into and from the secure container 22. These mechanisms will, for instance, validate notes through the use of multiple applications including ultraviolet scanning, infrared scanning, pattern recognition, size-, thickness- and mass scanning, note quality scanning and the like. In addition the cash acceptance terminal 20 includes a number of note counters to ensure a definitive document count into the secure container 22.

The process of withdrawal of transaction documents from the secure container 22 is the reverse of the depositing process.

With such definitive data pertaining to transaction documents in the secure container 22, it is possible (in cash only systems) to ensure that the notes reconcile at the cash processing centre. This could be as simple as weighing the notes as the system has definitive data about what went into the secure container 22 and it remains only to verify that what went into the secure container 22 is still in. This would enable an automated reconciliation process, bypassing the use of a conventional first note count at the cash processing centre.

In addition to the above, the cash acceptance terminal 20 also includes magnetic stripe and smart card readers, an identity tag or card reader, a biometric scanner or some other mechanism to verify one or more of client-, user- and operator identification, a receipt printer and sufficient onboard processing power to record and store the transactions undertaken with the use of the holding facility or cash acceptance terminal.

The fact that the secure container 22 and the cash acceptance terminal 20 contain such a definitive record makes it possible to use the container 2 ant terminal in a withdrawal and deposits process 24.

Since either or both the cash acceptance terminal 20 and the secure container 22 are provided with escrow or float facilities in which transaction documents can be stored for later withdrawal (prior to removal and arming of the secure container 22), the combination of the cash acceptance terminal 20 and secure container 22 can function, in effect as an automated teller machine or cash dispensing terminal.

In an example of this process, the secure container 22 accepts the deposit therein of the transaction documents pertaining to a variety of payments. So for instance the secure container 22 can be loaded with cash deposits by way of the cash acceptance terminal 20. In addition and since the cash acceptance terminal 20 is provided with card reading (smart card and magnetic stripe card readers) and transaction document printing facilities, the combination of the cash acceptance terminal 20 and secure container 22 can be used to facilitate other forms of payment, particularly credit card and smart card payments. This functionality can be enhanced with the use of authentication mechanisms, such as PIN-code entry facilities, identity card and tag readers or biometric scanning means. This will facilitate the loading of cash to card or smart card chip as well as cell phone airtime and electronic wallets, not to mention third party payments, account deposits, utility payments, lotto payments and payouts and the like.

With the addition of a keyboard and small display, the cash acceptance terminal 20 can be modified to accept cheque payments as long as a trained operator is available to facilitate such payment. This would interface to a bank or cheque processing agent for validation and authorisation and enable other options such as cashing of cheques.

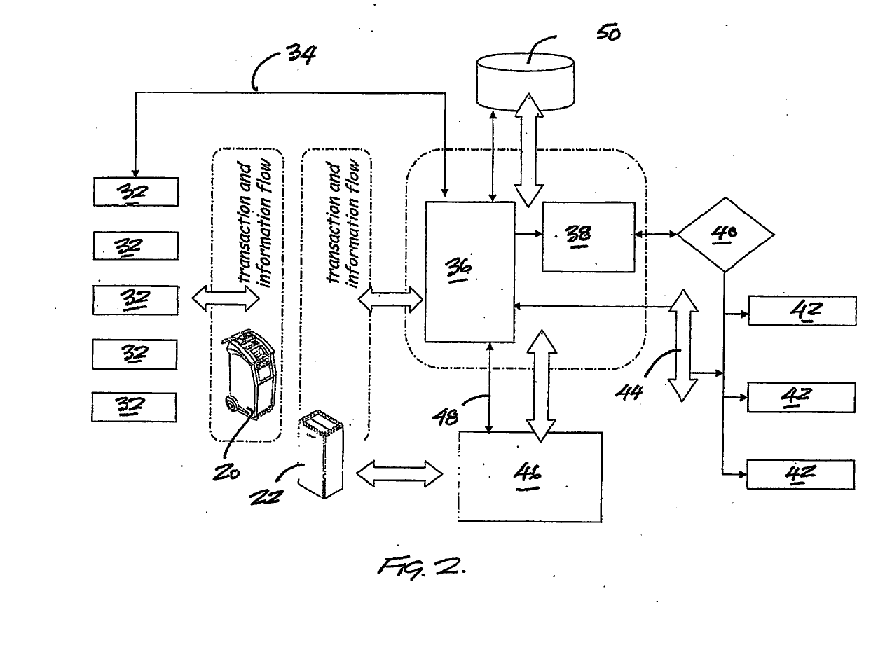

The payments process through the cash acceptance terminal 20 can be applied to any number of payment options provided the transaction management system includes the communications links envisaged (as illustrated in FIG. 2) between the user (in this case a retailer) who operates the cash acceptance terminal 20, financial institutions (who are required to provide the actual funds involved in the transactions) and beneficiaries of the payments. Exemplary beneficiaries include cell phone operators, utility operators participating retailers who can have their accounts paid by way of the system, lotto and voucher payments and electronic purse applications, such as appropriately enabled smart cards and cell phones.

To operate the combination of the secure container 22 and cash acceptance terminal 20 in the withdrawal and payment process 24, a participating client (the person wishing to make the payment) selects the payment option (cash, credit card, smart card or cheque) and either deposits the cash or otherwise records the transaction using the facilities available. In the case of cash, the cash acceptance terminal 20 verifies the quantity and quality of the cash (fraudulent and damaged bank notes are rejected and retained in the cash acceptance terminal 20 for eventual removal from the cash circulation system). The transaction management system then communicates with the payment beneficiary and the financial institution supporting the transaction and once the transaction is authorised, debits the clients banking or other financial account and credits the beneficiary account, using the communicates linkages provided by the transaction management system. The transaction documents involved in the transaction (bank notes, credit card slips, deposit and withdrawal slips or vouchers) are deposited within the secure, dye protected confines of the secure container 22 and the client is provided with a printed record of the transaction using the printing facilities of the cash acceptance terminal 20.

In the same withdrawal and payment process 24, the same or a different client can then request a cash withdrawal. Once again, the cash acceptance terminal 20 is used to process the transaction and communicates the transaction details to the appropriate financial institution.

In addition, the secure container 22 and cash acceptance terminal 20, in combination, can be used for special withdrawals, such as pension and lotto payouts, dividend payouts and salary payouts. In each case, the financial transaction is facilitated by means of the cash acceptance terminal 20 and the communication facilities thereof. The financial transaction is authorised by the appropriate financial institution or government, lotto or other payout authority and the cash is dispensed from the secure container 22 or from an escrow area housed within either or both the secure container 22 and the cash acceptance terminal 20. Where a cash payout is not required, the transaction is merely conducted electronically.

In each case, details of the transaction are printed out in a transaction record that the client may retain.

The secure container 22 in combination with the cash acceptance terminal 20 can also simulate an automated teller machine (ATM). In the ATM process 26, a client wishing to transact on the transaction management system uses their ATM card, credit card or other ATM-enabled card to interface with the cash acceptance terminal 20. In the event that deposits are to be made, the transaction documents (notes, cheques or the like) are deposited into the secure container 22 by means of the cash acceptance terminal 20 in the event that a cash withdrawal is to be made, the transaction is processed through the cash acceptance terminal 20 and cash (in the form of bank notes) is dispensed from the cash acceptance terminal 20 by retrieval thereof from the escrow/float facility in either or both the cash acceptance terminal 20 and the secure container 22. The withdrawal and payment process 24 and the ATM process 26 as well as the initialisation 12, registration 14, release 16 and the delivery 18 of the secure container 22 are all conducted and undertaken under the control of the transaction management system which imposes a track and trace process 28 on the entire transaction management system.

Each secure container 22 is preferably provided with a remote tracking device by means of which the secure container 22 can be tracked by means of remote sensing equipment. A number of tracking systems are available.

The tracking system is preferably configured such that the secure container 22 can be tracked during any of the processes outlined above, from the manufacturing process through to the cash centre process 30 outlined below.

The transaction management system is preferably configured to track the secure containers 22 in the transaction management system even if no alarm condition exists in relation to any secure container 22, but should an alarm condition arise, the tracking process 28 is designed to ensure that the secure container 22 is either tracked and recovered or the contents of the secure container 22 is rendered recognisable or useless through detonation of the dye pack in the secure container 22. In such a situation, the secure container 22 is adapted to send notification of such detonation to the transaction management system by means of a GSM, GPRS or other communications link, the idea being to use whatever spare capacity is left in the battery to activate a “beacon” to aid in the recovery process.

Not all alarm conditions occurring in respect of a secure container 22 need result in destruction or marking of the secure container 22 contents. For instance, a defective secure container 22 that is clearly not subject to alarm conditions need merely be tracked for purposes of receiving notification from the secure container 22 that a defect exists so that the secure container 22 can be removed from the transaction management system for repair.

In situations where alarm conditions occur, however, such as when the secure container 22 is subjected to an unauthorised opening attempt or the secure container 22 has been stolen or any conditions have occurred which give rise to the secure container 22 detonating the dye pack to destroy or mark the transaction documents (bank notes and other transaction documents) located within the secure container 22, the alarm condition will be signaled together with the tracking signal to the transaction management system. Clearly every attempt will be made to recover a defective or stolen secure container 22 or any secure container 22 in which the dye pack has detonated. Should this prove to be impossible, the transaction management system involves the use of unique trace elements. To this end, the dye contained in the dye pack of each secure container 22 may have a unique trace element incorporated therein, which trace element will be recorded during the initialisation process 12 or the registration process 14. The dye trace elements are selected from groups of chemicals that will penetrate the fabric of the transaction documents. If, therefore the persons who have made off successfully with dye stained transaction documents manage to remove all or part of the dye from the transaction documents, the trace element will still be detectable so that the transaction documents can be traced back to a particular secure container 22 and a particular detonation incident, both of which will be recorded on the transaction management system. This information could provide valuable assistance to law enforcement agencies.

In each case, when one of the secure containers 22 in the transaction management system has been filled to capacity or, in the situation in which the secure container 22 forms part of a scheduled delivery and emptying process or where scheduled maintenance of the secure container 22 is due, the secure container 22 will be removed from the cash acceptance terminal 20 by the user (for instance the authorised personnel of the retailer) or by the cash in transit service provider. The secure container 22 will then either be removed by the cash in transit operator or stored securely at the premises of the user for later removal.

In the preferred form of the invention, the secure container 22 is programmed to signal the transaction management system that the secure container 22 is full or ready for collection or due for maintenance.

The cash acceptance terminal is located at the premises of a participating retailer or other cash recipient, who has the opportunity of “banking” the contents of the secure container either regularly or when the secure container is filled to capacity.

When such “banking” is to be done, the secure container is collected by a cash in transit operator which delivers the secure container to the cash processing centre for further processing.

It may be preferable, particularly where large merchants are concerned, to aggregate a number of secure containers 22 fat the premises of a merchant before the containers 22 are transported to the cash processing centre by the cash in transit operator.

To this end, the system of the invention provides different types of holding facilities for multiple secure containers 22, each such facility being adapted to dock, receive and securely house a plurality of secure containers.

One form of secure container holder may be located at the premises of a merchant or other cash receiving point, the secure container holder being adapted to house a number of full or partly filled secure containers in a secure area.

In this form of the invention, the container holder takes the form of a secure container carousel within which one or more secure containers may be housed. The carousel is constituted by a secure enclosure that includes a cash in transit insertion point at which an empty secure container may be docked and inserted into the carousel by a cash in transit operator. When the merchant needs an empty secure container 22, the merchant's personnel go to a merchant extraction point forming part of the carousel at which an empty secure container (previously inserted into the carousel by the cash in transit operator) may be un-docked and removed from the carousel.

The secure container 22 so extracted is docked with a cash acceptance terminal and when it has been filled or partially filled (as the merchant may decide) the merchant's personnel un-dock the full or partly filled secure container 22 to docking means forming part of a merchant insertion point on the carousel, at which the full or partly filled secure container 22 may be docked and inserted into the carousel by the merchant.

The carousel is provided with a cash in transit extraction point at which the secure container may be un-docked and removed from the carousel by a cash in transit operator for transport to the cash processing centre.

Within the carousel, the secure containers 22 are transported between the insertion and extraction points by means of a conveyor.

Each of the extraction and insertion points are provided with bidirectional communications facilities by means of which data pertaining to the secure containers inserted and extracted from the carousel may be exchanged between the carousel, the secure containers and the transaction management system.

The cash in transit operator will transport the secure container 22 along with other secure containers 22, normally in secure vehicles for delivery to a cash processing centre.

A further form of secure container holder may be adapted for location in the vehicle of a cash in transit service provider, the secure container holder being adapted to house full or partly filled secure containers in a secure area accessible only to specifically authorised persons, such as supervisory personnel of a cash in transit operator or a cash processing centre.

At the cash processing centre, the secure container 22 is unarmed by means of a secure emptying jig. The jig contains a computer controlled system that interfaces with the transaction management system by way of networked computer communications. Preferably each secure container 22 is discharged directly into a bulk transaction document sorting and storage system.

The overall transaction management system is illustrated in FIG. 2 which shows a plurality of retailers 32 and other users of the transaction management system all of whom are in direct communications by way of a communications link 34, which may be any suitable communications link, including telecommunications, wireless communications, internet communications and GSM or GPRS communications) with a central systems controller 36.

The transaction management system may require the involvement of a sponsoring financial institution 38 to facilitate communications with an automated clearing bureau 40 and with participating financial institutions 42. All of these parties are interconnected and networked by means of appropriate communications links 44.

In addition, the transaction management system of this invention permits the automated processing of insurance matters, since the definitive data pertaining to each secure container 22 means that it is possible to determine an accurate insurance cost per container 22. Using the transaction management system, the secure container 22 and the tracking facility described above will provide accurate data pertaining to all authorised changes of custody of the secure container 22. In addition, the transaction management system can be programmed to submit an insurance claim electronically as soon as an insured incident should arise, notifying all interested parties at the same time, that the claim was submitted.

The central systems controller 36 is also in communication with participating central systems controllers 46 by means of communications links 48.

In addition to the transaction information flow by way of the communications link 34 between participating retailers 32 and the central systems controller, is also the transaction and information flow constituted by movements of the secure containers 22 and interfaces with the cash acceptance terminals 20 forming part of the transaction management system.

Since the transaction management system provides an accurate and simple mechanism of monitoring transaction flows within a financial system and the movement of cash in particular, it might also be appropriate for the central bank (in the case of South Africa, the South African Reserve Bank 50) to have a direct communications link with the central systems controller, since this will enable the central bank to obtain a much clearer view of the movement of cash within the financial system and daily commerce.

The transaction management system of the invention has the capacity to interface directly with retailers' point of sales and other transaction and business process management systems and to interface with CCTV and other surveillance systems.

In a developed form, the transaction management system could also be integrated into point of sale and retailers' till point systems such that the system resides at each till point. Cash is then collected through a mobile collection station or till point cash acceptance terminal that accommodates a secure container 22 and docks with each till to collect cash and transaction data. This would enable management of so-called till floats where a cash dispensing mechanism may be installed to enable the float to be accessed, thereby allowing a teller simply to enter the amount paid and, based on the value of goods purchased, to have the system dispense the correct amount of change from the secure container 22 docked within the till point cash acceptance terminal.

Such an extended system will interface to the retailer point of sale system and in effect balance the till at change of cashier, cash up time or the like.

The benefit of this development of the system is that the float would not necessarily be required to be handed in at the end of a shift or business day and the handover process would only be focused on cheques, coins and vouchers.

Coin, cheque and voucher acceptance along the same lines can be added as an extension of this development of the transaction management system if the system is enhanced to scan images of the cheques and vouchers and make these available to the retailer or bank for query handling.

The secure containers 20 are integral to the transaction management system illustrated in Figure as it does on the utilisation of a plurality of these secure containers in a centrally managed system.

The transaction management system 100 includes a plurality of individually identifiable secure container holding facilities constituted by cash acceptance terminals 112 located at the premises of participating merchants 114, which may be single merchants or a plurality of participating merchants sharing one or more cash acceptance terminals 112.

In addition, the system includes a plurality of individually identifiable secure containers or secure containers, each adapted to dock with and un-dock from a cash acceptance terminal 112.

The participating merchants 114 regularly take part in commercial transactions in each of which the merchant 114 receives one or more transaction documents reflecting monetary value, from one or more purchasers 116 in exchange for goods delivered or services rendered.

The merchant 114 will, in each such transaction, deposit the transaction documents received from the purchaser into the secure container docked within the cash acceptance terminal 112 of that merchant 114. The transaction documents are typically constituted by money, cheques, credit card vouchers, deposit- and withdrawal vouchers or slips and printouts of electronic payment records.

Cash money is simply fed into the cash acceptance terminal where it is scanned, validated and counted into the secure container. In addition, the cash acceptance terminals 114 are provided with data entry facilities, such as card readers, SIM card readers, keypads and the like by means of which detailed data pertaining to each. transaction, including transactions involving transaction documents other than cash, may be recorded in the cash acceptance terminal.

The secure containers and the cash acceptance terminals 112 are adapted for bidirectional communication so that the data recorded in the cash acceptance terminal 112 is communicated to the secure container.

Events that affect the secure container uniquely, such as malfunctions or events that compromise the integrity of the container or the transaction documents contained within the container are first recorded by the container programmable logic and then communicated to the cash acceptance terminal 112.

The secure container inside the cash acceptance terminal 112 serves as a repository for actual cash and the drop safe serves as a repository for transaction documents other than cash, but both forms of transaction are recorded in either or both the cash acceptance terminal and the secure container and drop safe.

The transaction management system 100 includes a central server 118 in communication with the data processing system of at least one financial institution 120 with whom the merchants 114 have banking accounts.

The cash acceptance terminals 112 are programmed to communicate with the server 118 to transmit the data pertaining to the transactions recorded in the cash acceptance terminal 112, which includes data first recorded in the secure container and communicated to the cash acceptance terminal 112.

The system 100 may be programmed for each cash acceptance terminal 112 to communicate with the financial institution 120 at a prescribed time or times or when the secure container in the cash acceptance terminal 112 is filled to capacity. Alternatively the merchant 114 may initiate communications manually or, with bidirectional communications between the server 118 and the cash acceptance terminals 112, the server 118 may be programmed to initiate communications

The other participants in the transactions managed by the system 100 are the purchasers 116 who are also in a position to use the cash acceptance terminals 112 as banking facilities. To this end, the system 100 may conveniently be programmed to record, in respect of each transaction, at least the purchaser's banking details and to communicate these details to the financial institution where the purchaser has a banking account. Depending on the transaction, the financial institution will debit the purchaser's bank account if a purchase has been made.

Using a cash acceptance terminal with a facility to recirculate cash within the terminal and to dispense cash from the terminal, the system may also be programmed to allow the cash acceptance terminals 112 to dispense cash and credit value, thereby allowing a purchaser to use a cash acceptance terminal 112 much like an automated teller machine (ATM) to draw cash, to transfer money between accounts, to pay the purchaser's creditors (bill payment) or deposit cash into the purchaser's account.

The system 100 may conveniently be programmed to notify either the merchant 114 or the purchaser of such communication and, on conclusion of the credit or debit entry on the merchant's account or the purchaser's account, as the case may be, to confirm the credit or debit entry, preferably electronically by electronic mail, SMS or the like to the merchant or purchaser. In addition, the system 100 may be adapted to communicate an electronic notification to either or both the secure container holding facility and the secure container to confirm that these banking accounts have been credited or debited. This will facilitate reconciliation and synchronisation of accounts and data within the system 100.

In addition to the communications facility offered by the electronic record stored in or on the secure containers, the system 100 conveniently includes parallel communications media including networked computer communications, telecommunications and communicating via the internet or GSM, GPRS or wireless networks. In situations where the cash acceptance terminal 112 communicates with the server 118 before the secure container in the cash acceptance terminal 112 is filled to capacity, the system 100 is programmed to reconcile the accounting, transaction and value data between the time of current communication and the time of last communication.

To enhance the security of the system 100, the security and trustworthiness of the secure container is paramount.

Using a cash acceptance terminal as an example, in the process of docking the secure container with the cash acceptance terminal, an empty secure container is located in the cash acceptance terminal docking bay through a normally locked docking bay door, which is opened for this purpose. Both the cash acceptance terminal and the secure container are provided with programmable logic that is programmed to automate and co-ordinate the operation of the cash acceptance terminal and the secure container. Only once the cash acceptance terminal docking bay door has been closed and secured will the automated docking process commence, in which the cash acceptance terminal and the secure container, operating in programmed unison, automatically unlock and open the normally locked cash feed hatch of the secure container and mechanically interface the entrance of the feed hatch with the exit chute of the banknote transport system forming part of the secure container holding facility. This allows cash, typically banknotes, to be fed into the secure container by way of the cash acceptance terminal feed chute and banknote transport system.

The cash acceptance terminal is programmed to only open the secure container to accept cash when the secure container docking bay door in the terminal has been closed and secured.

In the reverse of this process when the secure container is un-docked (for instance when it is removed by cash in transit personnel for transport to a cash processing centre), the cash acceptance terminal and the secure container, operating in programmed unison, automatically close and lock the feed hatch of the secure container. Only once the feed hatch has been locked, will the cash acceptance terminal program unlock and permit opening of the cash acceptance terminal docking bay door.

In the light of the secure nature of the system 100, particularly the secure containers and the secure container holding facilities constituted by the cash acceptance terminals 112, the system 100 has guaranteed trustworthiness. There is a high degree of trust built into the system, both in the security of the components and in the audit trails yielded by the system 100, to the extent that participating financial institutions 120 are able, with a high degree of certainty, to credit and debit the banking accounts of the participating merchants 114 and purchasers with the monetary value communicated to the financial institutions 120.

In addition, by configuring cash dispensing machines such as ATMs 122 for use in the system 100, the system 100 of the invention can be converted into a fully fledged transaction management system. To do this, the ATMs 122 would have to be configured to be equivalent to the secure container holding facilities as described above and to use secure containers such as those described above as cash and transaction document stores.

Conventionally, a transaction management system such as this would require the transport of cash to and from a cash processing centre 124.

However, using an appropriate tracking and scheduling system, the central server 118 can now be programmed to record the identity and location of each cash acceptance terminal 112, each ATM 122 and in fact every other secure container holding facility forming part of the system 100, which also record and track every secure container in the system 100. In addition, the system 100 will record all transactions and the monetary value, in the form of actual cash and value represented by other transaction documents, stored in or to be obtained from each secure container holding facility and secure container in the system. This will enable the system operator and the participating financial institutions 120 with the ability to manage and schedule cash and the flow of cash within the system 100 without necessarily routing each cash consignment through a cash processing centre 124 or financial institution 120.

In respect of banknotes, the system may conveniently include means to record the location of each note or of classes of notes within the secure containers.

In addition, the cash acceptance terminals 112 may be configured to verify and record the fitness of each banknote fed into the terminal, for instance whether or not the note is ATM-ready or whether it must be shipped to a cash processing centre, a bank or possibly even for destruction.

One or more cash acceptance terminals 112 within the system 100 may conveniently include one or more internal escrow areas within which cash and banknotes in particular may be placed temporarily, in addition to or instead of placing the cash only into the secure container as well as means to recirculate the cash between escrow areas and the secure container. Using such cash acceptance terminals, the system 100 may be programmed to sort the banknotes into the secure container to suit the known cash requirements of one or more of the other participating merchants 114 in the system.

For instance, one of the participating merchants in the system may be a retailer that receives large amounts of cash while the next merchant may be a nearby pension payment station which requires banknotes in certain denominations. The server 118 may then be programmed to issue and communicate an instruction to the cash acceptance terminal to fill one or more secure containers with banknotes to meet those requirements. The cash in transit operator will then be issued with an instruction to collect those secure containers from the retailer and deliver the containers directly to the pension payment station.

The use of secure containers pre-loaded with cash appropriate to a particular cash delivery will also serve to reduce the potential for fraud within the system 100. At present there is such a risk, since cash in transit and bank personnel are required to load cash dispensing equipment such as ATMs manually, thereby introducing the possibility to exchange non-compromised banknotes with compromised notes in the loading process. It is presently possible for instance, for dishonest personnel to replace good banknotes with counterfeit notes in the cash dispensing equipment and to retain the good notes.

Cash in transit personnel, in servicing merchants and cash dispensing equipment located in remote locations, such as rural towns and villages, are often required to travel long distances on a daily basis to deliver and collect cash. Using the system 100 of this invention, participating merchants would be able to create a localised sub-system within which cash collected by retailers could be recirculated, in secure containers, to cash dispensing equipment, such as pension payment stations, ATMs and cash dispensers located at the premises of the merchants, using local bank and cash in transit personnel and only infrequent attendance by out of town cash in transit personnel.

The transaction management system 100 described above is essentially a cash bank with a cash repository that is not constituted by a conventional vault, but by a virtual repository constituted by the secure cash acceptance terminals 112, cash dispensing terminals (such as the ATMs 122) and secure containers that are all tracked and audited by the system 100.

At the retail end of the transaction management system of this invention the system may include a number of static cash acceptance terminals such as retail till points located in the premises of a retailer, merchant or any entity that receives large amounts of cash, including a financial institution.

The till points accept and store cash in a container located within the till point, normally a cash drawer which, in this case is preferably constituted by a secure container docked within terminal.

The system includes at least one mobile cash acceptance terminal with at least one secure container docked within it. The mobile terminal is preferably mounted on wheels or castors so that it can be wheeled from till to till. At each till point the mobile cash acceptance terminal is docked with the till and automatically unloads the cash stored in the till secure container into a secure container docked within the mobile cash acceptance terminal.

Once the mobile cash acceptance terminal has made its rounds of till points or when the secure container in the mobile cash acceptance terminal is full, the mobile cash acceptance terminal is wheeled to a central cash store where a static cash acceptance terminal, preferably with a number of secure containers docked within it, is housed. The mobile cash acceptance terminal is adapted to dock with the static cash acceptance terminal and to load cash stored within the mobile cash acceptance terminal into the central cash store terminal central storage thereof and later removal by cash in transit personnel.

The static cash acceptance terminals and the central cash store terminal are connected together in a communications network to enable cash counts and reconciliation between the various terminals. In addition, the mobile cash acceptance terminal and the static cash acceptance terminals are enabled for bidirectional communication so that the movement of cash with the aid of the mobile cash acceptance terminal can also be brought to account each time the mobile cash acceptance terminal is interfaced with a static cash acceptance terminal.

With the use of perimeter alarms and proximity sensors, among others, the system can be adapted to monitor the movement of the mobile cash acceptance terminal and to raise an alarm if the mobile cash acceptance terminal exceeds the parameters of a predefined, restricted set of movements. For instance the system may be adapted to detonate a dye canister in each of the secure containers docked within the mobile cash acceptance terminal in the event that any attempt is made to move the mobile cash acceptance terminal beyond a predefined perimeter in or around the premises where the system is implemented.

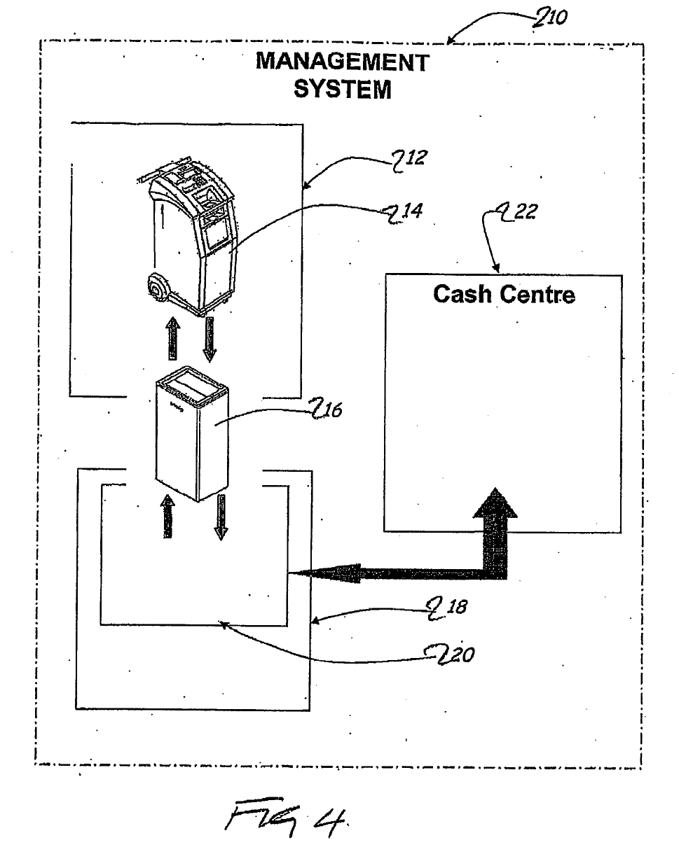

A variation of the system is illustrated in FIG. 4 in which the transaction management system 210 of this invention, a retailer 212 or other cash receiver deposits cash through a cash acceptance device or terminal 214 into a secure container constituted by a secure container 216, preferably a dye protected container.

At predetermined times the secure container 216, normally together with a number of similar secure containers 216, is removed by a cash in transit service provider with the use of a cash in transit vehicle.

In conventional systems, the cash in transit service provider personnel transport the secure containers 216 “across pavement”, load them into a cash in transit vehicle and transport the secure containers 216 to a cash processing centre, thereby in effect, removing the secure containers 216 from circulation.

Using the system of this invention, the cash in transit service provider transports the secure containers 216 across pavement and docks them, one by one (or in multiples, in more advanced systems 210) with a secure CIT vehicle module 220 mounted within the cash in transit vehicle 218.

The vehicle module 220 Is essentially a secure, mobile temporary cash storage facility consisting of a secure enclosure which could be a type of safe of a specified category, depending on security requirements.

The secure CIT vehicle module 220 may conveniently be protected by means of a dye mechanism that can be activated either automatically when the integrity of the secure CIT vehicle module 220 is compromised or manually or remotely, to release a document staining dye into the interior of the module 220, thereby to stain and mark the contents of the secure CIT vehicle module 220 as compromised.

The secure CIT vehicle module 220 has the facility to open the secure containers 216 docked with it, using the communication devices and security and encryption systems conventionally used to open the secure containers 216 and to deposit the contents of each secure container 216 into the module 220. This is similar to the manner in which secure containers 216 are opened and emptied at a cash processing centre using typical cash handling facility emptying jigs. The vehicle module 220 serves as a facility for the interim storage of the cash and documents which are deposited into the module 220, in bulk.

The secure containers 216 are un-docked once unloaded and returned to the retailer 212.

All actions are electronically recorded for auditing, tracking and tracing purposes and sent through to a central information management system, either from the retailer's cash acceptance terminal 212 or from the secure CIT vehicle module 220, which will be provided with secure communications facilities for this purpose.

It will be appreciated that the cash in transit personnel have no access to the cash contained in the secure containers 216 or the opening mechanisms for the containers 216, which are contained within the secure CIT vehicle module 220. The cash in transit service provider's personnel are in fact separated from the cash handling process and serve only to transport the secure containers 216 across the pavement, dock the secure containers 216 with the secure CIT vehicle module 220 and to drive the cash in transit vehicle 218.

Once the cash in transit service provider personnel have recovered the requisite number of secure containers 216 (by docking them with the secure CIT vehicle module 220) the cash temporarily stored in the secure CIT vehicle module 220 is transported, within the secure CIT vehicle module 220, to a cash processing centre 222.

At the cash processing centre 222 the secure CIT vehicle module 220 is either removed from the cash in transit vehicle 218 and docked to a docking station or other processing jig at the cash processing centre that interfaces and preferably automatically removes the cash from the secure CIT vehicle module 220. Cash is removed and counted through a bulk processing mechanism to verify the total of all the secure containers 216 contents deposited into the secure CIT vehicle module 220. The module 220 may also be integrated with the cash in transit vehicle 218 to the extent that the vehicle 218 is parked and the secure CIT vehicle module 220 is docked with the processing jig at the cash processing centre without removal thereof from the vehicle 218.

The secure CIT vehicle module 220 is preferably electronically opened, but could be opened manually using physical keys.

Secure CIT vehicle module 220 information stored in the module programmable logic is transmitted or extracted and relayed to the cash processing centre 222 computers where it is reconciled with information previously recorded on the central information management system for auditing, tracking and tracing purposes.

To improve the security of the secure CIT vehicle module 220, the module 220 or a part of the module (such as a safe located within the module) may conveniently be adapted to drop from the cash in transit vehicle 218 in the case of a brute force attack, such as a cash in transit heist. The module or component that is dropped being of a weight and size that would restrict removal of module 220 or component from where it is dropped.

Additional deterrents could also be used to discourage the removal of the secure CIT vehicle module 220, including smoke signalling mechanisms, alarm mechanisms, electrical shock devices, foams, glues, oils or other mechanisms that make it difficult to move the module 220 such as blade-like extrusions.

Preferably cash will be deposited and stored in the secure CIT vehicle module 220 in an ordered fashion, possibly in the sequence in which the secure containers 216 were processed. It might be appropriate to batch cash to each secure container 216, but none of these measures should detract from one of the principal aims of this system which is to focus is on efficiencies within the cash processing centre 222 where a single cash count will yield the greatest system efficiency.

To enhance the system 210, the information management system supporting the invention must be information rich with a plurality of information sources. This information, which will all be communicated to and recorded in the central information management system, will include primary and supporting information exchanged between:
the retailer's cash acceptance terminal 212 and the secure container 216;
the secure container 216 and the secure CIT vehicle module 220;
the secure CIT vehicle module 220 and the cash in transit vehicle 218;
the cash in transit vehicle 218 and secure CIT vehicle module 220 and the cash processing centre 222; and
the cash processing centre 222 and the retailer 212.

The information management system will be programmed, at least, to:
supply routing and collection information to the cash in transit vehicles 218 managed within the system 210;
record the collection and progress of the vehicles 218;
statically show the efficiencies of the process (vehicles, collection times and volumes, for instance);
track and trace throughout the process;
indicate financial contents of each cash in transit vehicle 218 (for definitive insurance) at any point in time;
indicate historical trends in respect of cash collection and vehicle usage; and
do financial reconciliation and generate credits on retailers' accounts.

The advantage of the system of this invention is that it reduces logistical inefficiencies in current systems as well as excessive secure container movement. In the system of the invention, a retailer 212 is allocated a fixed or variable number of secure containers 216 that are returned to the retailer 212 immediately after processing by the secure CIT vehicle module 220 instead of being removed from site when the cash in transit service provider collects cash from the retailer 212. In addition, the system bulks cash and reduces processing at the cash processing centre 222, where a single count process can be implemented. The system 210 also reduces maintenance requirements by greatly reducing transport wear on the secure containers 216 and as such reduces overall system support costs.

1. A transaction management system including:
a plurality of individually identifiable secure container holding facilities;
a plurality of individually identifiable secure containers each adapted to dock with and un-dock from a secure document handling facility;
the container holding facilities being adapted for location at the premises of a plurality of participating merchants, each of whom, in use, takes part in transactions in each of which the merchant receives one or more transaction documents reflecting monetary value, from one or more purchasers in exchange for goods delivered or services rendered and in which the merchant deposits, into a secure container docked within the holding facility, the transaction document or documents involved in that transaction;
each secure container and holding facility including bidirectional communication means adapted to communicate, to and from the secure containers, data pertaining to the monetary value of each transaction document deposited in the secure container;
a central, computerised transaction management facility in communication with the data processing system of at least one financial institution with which the merchants have banking accounts;
means to communicate at least the monetary value data recorded by the holding facilities to the central, computerised transaction management facility; and
the server being programmed, on receipt of a communication from a holding facility located at the premises of a merchant, to communicate data pertaining to the combined monetary value of all the transaction documents deposited within the secure container to the financial institution with whom the merchant has a banking account.

2. A transaction management system according to claim 1 in which, notwithstanding that multiple deposits of transaction documents from a single merchant are made into the secure container, the communication to the financial institution is recorded as a single credit to the banking account of the participating merchant.

3. A transaction management system according to claim 1 in which, in the situation in which the merchant receives cash for the account of the merchant and for the account of others, the system is programmed to permit the merchant to deposit cash into the secure container and to designate the account or accounts to be credited in respect of that deposit.

4. A transaction management system according to claim 1 which is adapted to enable a purchaser to use the secure container holding facility as a bank cash withdrawal facility, the transaction management system being programmed:
to record data pertaining to the cash withdrawal required and the purchaser's banking details;
to communicate this data to the financial institution where the purchaser has a banking account;
to instruct the financial institution to debit the purchaser's bank account with the amount withdrawn;
to instruct the financial institution to credit the merchant's bank account with the amount withdrawn;
to dispense cash to the purchaser from the secure container holding facility.

5. A transaction management system according to claim 1 which is adapted to enable a purchaser to use the secure container holding facility as a cash account payment facility, the transaction management system being programmed:
to instruct the container holding facility to accept the in-feed of the payment in cash into the container holding facility;
to record data pertaining to the cash payment fed into the container holding facility and the account payee's banking details;
to communicate this data to the financial institution where the account payee has a banking account; and
to instruct the financial institution to credit the payee's bank account with the amount withdrawn.

6. A transaction management system according to claim 1 which is adapted to manage transactions concluded within the system as well as the contents of each secure container under the control of the central, computerised transaction management facility, using bidirectional communications between the secure container holding facilities, the secure containers, participating merchants, one or more participating cash processing centres and one or more participating financial institutions.

7. A transaction management system according to claim 6 in which the central transaction management facility includes programmable logic means to record the identity and location of each secure container holding facility and secure container in the system as well as an indication of the monetary value, in the form of actual cash and value represented by other transaction documents, stored or to be obtained from each secure container holding facility and secure container.

8. A transaction management system according to claim 7 in which the central facility and the participating financial institutions are provided with programmable logic means programmed to manage and schedule cash transfers and the flow of cash within the system without necessarily routing each cash consignment through a cash processing centre or financial institution.

9. A transaction management system according to claim 8 which includes means to record and report on the location and fitness for use of the banknotes within the secure containers, maybe not all

10. A transaction management system according to claim 1 which includes one or more secure container holding facilities which each includes one or more internal escrow areas, means to feed cash of a particular type from the container holding facility in-feed mechanism temporarily into discrete escrow areas, in addition to or instead of placing the cash into the secure container, and cash feed means to recirculate the cash between the escrow areas, the secure container and the container holding facility in-feed mechanism

11. A transaction management system according to claim 1 in which the central facility, the container holding facilities and the secure containers are programmed such that no secure container can be opened without compromising the integrity of the secure container unless it is empty of all transaction documents or it is securely locked within and electronically interfaced with a secure container holding facility.

12. A transaction management system according to claim 1 in which each secure container includes programmable logic means to record and store data pertaining to each transaction document stored within the secure container, the secure container including means to communicate, to a control device located externally of the secure container, information pertaining to the secure container and each transaction document.

13. A transaction management system according to claim 12 in which at least some of the secure containers are adapted to facilitate the recycling and withdrawal of transaction documents from the secure container, each such container including one or more compartments additional to a main transaction document holding compartment, which additional compartments are adapted to constitute escrow areas, float compartments or holding areas for denomination-specific transaction documents from which the or such documents can be dispensed in use.

14. A transaction management system according to claim 12 in which the secure containers are each provided with an on-board processor with sufficient computing power and memory to store a record of the transactions involving the secure container or any holding facility within which the secure container is held, including data pertaining to transaction documents deposited into the container, transaction documents withdrawn from the container (or any additional compartment, whether forming part of the container or the holding facility within which the container is housed), all deposits into the secure container (or any additional compartment, whether forming part of the container or the holding facility within which the container is housed), all withdrawals from the secure container (or any additional compartment, whether forming part of the container or the holding facility within which the container is housed) and data pertaining to all transaction documents housed within the secure container and data pertaining to the operational history of the container and a record of any mishandling of the container.

15. A transaction management system according to claim 1 including one or more bulk container holding facilities adapted to house a plurality of secure containers in a secure area.

16. A transaction management system according to claim 15 in which the bulk secure container holding facility is constituted by a secure container carousel within which one or more secure containers may be housed, the carousel including:
a cash in transit insertion point including docking means at which an empty secure container may be docked and inserted into the carousel by a cash in transit operator;
a merchant extraction point at which an empty secure container may be un-docked and removed from the carousel by the merchant;
a merchant insertion point including docking means at which a full or partly filled secure container may be docked and inserted into the carousel by the merchant;
a cash in transit extraction point at which the secure container may be un-docked and removed from the carousel by a cash in transit operator; and
conveyor means to transport the secure containers in the carousel between the insertion and extraction points;
Each extraction point being provided with bidirectional communications facilities by means of which data pertaining to the secure containers inserted and extracted from the carousel may be exchanged between the carousel, the secure containers and the transaction management system.

17. A transaction management system according to claim 1 including a bulk container holding facility that is adapted to house a plurality of secure containers, the facility being constituted by a secure area incorporated into a vehicle of a cash in transit service provider, the bulk facility being adapted to house full or partly filled secure containers in an area accessible only to specifically authorised persons, such as supervisory personnel of a cash in transit operator or a cash processing centre.

18. A transaction management system according to claim 17 in which the bulk facility is a secure vehicle module adapted for mounting in a cash in transit vehicle or the like, the module being constituted by a dye protected, secure facility which is adapted to dock, sequentially and at least one at a time, with a plurality of secure document containers:
to open each secure document container in a manner similar to a cash handling facility emptying jig;
to deposit the contents of the secure document container into the module for storage of the transaction documents so deposited; and
to un-dock the secure document container;
the module including programmable logic adapted to record, preferably by means of communication with the secure document container programmable logic, the bulk transaction documents deposited from the secure document container and a record of each secure document container docked with and un-docked from the module.

19. A transaction management system according to claim 17 in which the secure vehicle module includes bidirectional communication means to permit communication between the secure containers, the vehicle module and the central, computerised transaction management facility.

20. A transaction management system according to any one of the claim 1 including:
a plurality of static container holding facilities, each adapted to accept and store cash in a container located within the terminal; and
at least one mobile container holding facility with at least one secure container docked within it;
the mobile terminal being adapted to dock with each static terminal and to unload cash stored in the static terminal into the secure container docked within the mobile container holding facility.

21. A transaction management system according to claim 20 in which the static container holding facilities are constituted by retail till points or point of sale cash collection points, the system including at least one additional static container holding facility having at least one secure container docked within it, constituting a central cash store, the mobile container holding facility being adapted to dock with the static container holding facility and to load cash stored within the mobile container holding facility into the static container holding facility for storage thereof in one or more secure containers docked within the central static container holding facility.

22. A transaction management system according to claim 20 in which the static container holding facilities are connected together in a communications network.

23. A transaction management system according to claim 20 which includes means to monitor the movement of the mobile container holding facility and to raise an alarm if the mobile container holding facility exceeds the parameters of a predefined, restricted set of movements.
